(19) United States
(12) Patent Application Publication
(10) Pub. No.: US 2013/0189105 A1
(43) Pub. Date: Jul. 25, 2013

(54) VIBRATION ABSORBING DEVICE FOR A WIND TURBINE AND METHOD OF ABSORBING VIBRATIONS IN A WIND TURBINE

(71) Applicant: Laurent BONNET, Mesum (DE)

(72) Inventor: Laurent BONNET, Mesum (DE)

(21) Appl. No.: 13/355,025

(22) Filed: Jan. 20, 2012

(51) Int. Cl. F03D 11/00; F16F 15/12; F03D 11/02

(52) U.S. Cl. 416/145; 74/574.4

(57) ABSTRACT

A wind turbine is provided including a nacelle housing a power train of the wind turbine. The power train of the wind turbine includes a gearbox, a generator, and one or more rotatable shafts, each including a radial direction and an axial direction. Further, the wind turbine includes a vibration absorbing device being arranged on a shaft of the power train. The vibration absorbing device includes an energy storing arrangement, which includes a flexible element and a mass assembly. The vibration absorbing device is connected to the shaft in an axially symmetric way.

### BACKGROUND OF THE INVENTION

The subject matter described herein relates generally to methods and systems for absorbing vibrations in a wind turbine, and more particularly, to methods and systems for absorbing vibrations in the power train of a wind turbine.

At least some known wind turbines include a tower and a nacelle mounted on the tower. A rotor is rotatably mounted to the nacelle and is coupled to a generator by a shaft. A plurality of blades extends from the rotor. The blades are oriented such that wind passing over the blades turns the rotor and rotates the shaft, thereby driving the generator to generate electricity.

Often, the torque of the bladed rotor is transferred by a main low speed shaft located in the wind turbine nacelle. Further, the low speed shaft leads to a gearbox featuring a single or multiple complimentary gear stage(s), which is/are often mounted on the main frame of the nacelle. The gearbox generates an output to a high speed shaft according to a gear ratio. A coupling shaft provides the interface between the gearbox and the generator. The generator includes a rotor and a stator which generates on-line output electrical current from the rotational energy delivered by the coupling shaft.

The stages of the gearbox (such as low speed and medium speed gear stages of the gearbox) produce vibrations in a gear meshing frequency, which may be transmitted through the low speed shaft and the lateral mounting interfaces of the gearbox. Also, medium speed and high speed gear stages of the gearbox produce vibrations in a gear meshing frequency, which may be transmitted through a coupling shaft and the lateral mounting interfaces of the gearbox. Further, the generator produces vibrations of a rotor-stator pole meshing frequency, which is transmitted through the high coupling shaft and the lateral mounting interfaces of the generator. The vibrations generated by the gearbox meshing and the generator meshing cause noise and result in a shorter lifetime of the bearings of the above described shafts.

Due to the increasing use of wind turbines, in particular near residential areas, there is a desire to minimize the noise production of the wind turbines. Further, as maintenance items are cost intensive, an increased lifetime of wind turbine components, such as bearings, is desirable.

### BRIEF DESCRIPTION OF THE INVENTION

In one aspect, a wind turbine is provided including a nacelle housing a power train of the wind turbine. The power train of the wind turbine includes a gearbox, a generator, and one or more rotatable shafts, each including a radial direction and an axial direction. Further, the wind turbine includes a vibration absorbing device being arranged on a shaft of the power train. The vibration absorbing device includes a flexible element and a mass assembly. The vibration absorbing device is connected to the shaft in an axially symmetric way.

In another aspect, a vibration absorbing device for a wind turbine is provided. The wind turbine may include a shaft of a power train including a radial direction and an axial direction along a shaft axis. The vibration absorbing device may include an inner ring for connecting the vibration absorbing device on a shaft of the wind turbine and an energy storing assembly including a flexible element and a mass assembly on the flexible element, wherein the mass assembly is arranged substantially axially symmetric to the shaft axis.

In yet another aspect, a gearbox for a wind turbine is provided. The gearbox may include a shaft including a radial direction and an axial direction along a shaft axis. Further, the gearbox may include a vibration absorbing device on the shaft including a vibration energy storing assembly. Typically, the vibration energy storing assembly includes a flexible element and a mass assembly on the flexible element, wherein the mass assembly is arranged substantially axially symmetric to the shaft axis.

Further aspects, advantages and features of the present invention are apparent from the dependent claims, the description and the accompanying drawings.

### BRIEF DESCRIPTION OF THE DRAWINGS

A full and enabling disclosure including the best mode thereof, to one of ordinary skill in the art, is set forth more particularly in the remainder of the specification, including reference to the accompanying figures wherein:

FIG. 1 is a perspective view of an exemplary wind turbine.

FIG. 2 is an enlarged sectional view of a portion of the wind turbine shown in FIG. 1.

FIG. 3 is a schematic cross-sectional view of a power train of a wind turbine according to embodiments described herein.

FIG. 4 is a schematic cross-sectional view of a gearbox according to embodiments described herein.

FIG. 5 is a schematic view of a vibration absorbing device according to embodiments described herein.

FIG. 6 is a schematic view of a vibration absorbing device according to further embodiments described herein.

FIG. 7 is a schematic view of a vibration absorbing device according to yet further embodiments described herein.

FIG. 8 is a schematic view of a vibration absorbing device having spring elements according to embodiments described herein.

FIG. 9 is a schematic cross sectional view of a vibration absorbing device in a housing according to embodiments described herein.

FIG. 10 is a schematic view of a flexible element of the vibration absorbing device according to embodiments described herein.

FIG. 11 is a schematic view of a flexible element of the vibration absorbing device according to further embodiments described herein.

FIG. 12 is a schematic view of a flexible element of the vibration absorbing device according to further embodiments described herein.

FIG. 13 is a schematic view of a flexible element of the vibration absorbing device according to further embodiments described herein.

FIG. 14 is a schematic view of a flexible element of the vibration absorbing device according to further embodiments described herein.

FIG. 15 is a diagram showing examples of frequencies absorbed by the vibration absorbing device according to embodiments described herein.

FIG. 16 is a schematic flow chart of a method for absorbing vibrations in a wind turbine according to embodiments described herein.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

The embodiments described herein include a wind turbine system including a vibration absorbing device at the source of the vibrations, such as the machinery, that reduces wind turbine rotating machinery tonal noise emission, which is characteristically a disturbing tonal noise. More specifically, the vibrations are absorbed at the location of their origin, for instance by mounting an absorbing device directly on a rotating shaft or a bearing ring at the stage where the discrete “meshing” vibration is created. The meshing vibration to be absorbed by the vibration absorbing device, and, thus, to be reduced, may typically be generated by the gearbox meshing and the generator meshing. In addition, a wind turbine is provided with low tonal noise emission by reducing the dynamic excitation of the “meshing” of the rotating machinery directly at the source of the vibrations with a specific vibration absorbing device or a specific vibration dynamic absorber device tailored to the specific relevant stage and tuned to the specific frequency/-ies.

As used herein, the term power train is intended to be representative of components that transmit and convert power. For instance, in a wind turbine, the power train may be defined as including the rotor, the gearbox, and the generator, as well as the shafts of the gearbox and the shafts connecting the rotor, the gearbox and the generator. Typically, the power train includes the rotor low speed shaft, a coupling shaft between the gearbox and the generator, the output high speed shaft of the generator, and shafts of the gearbox low speed stage and the gearbox high speed stage. As used herein, the term “blade” is intended to be representative of any device that provides a reactive force when in motion relative to a surrounding fluid. As used herein, the term “wind turbine” is intended to be representative of any device that generates rotational energy from wind energy, and more specifically, converts kinetic energy of wind into mechanical energy. As used herein, the term “wind generator” is intended to be representative of any wind turbine that generates electrical power from rotational energy generated from wind energy, and more specifically, converts mechanical energy converted from kinetic energy of wind to electrical power.

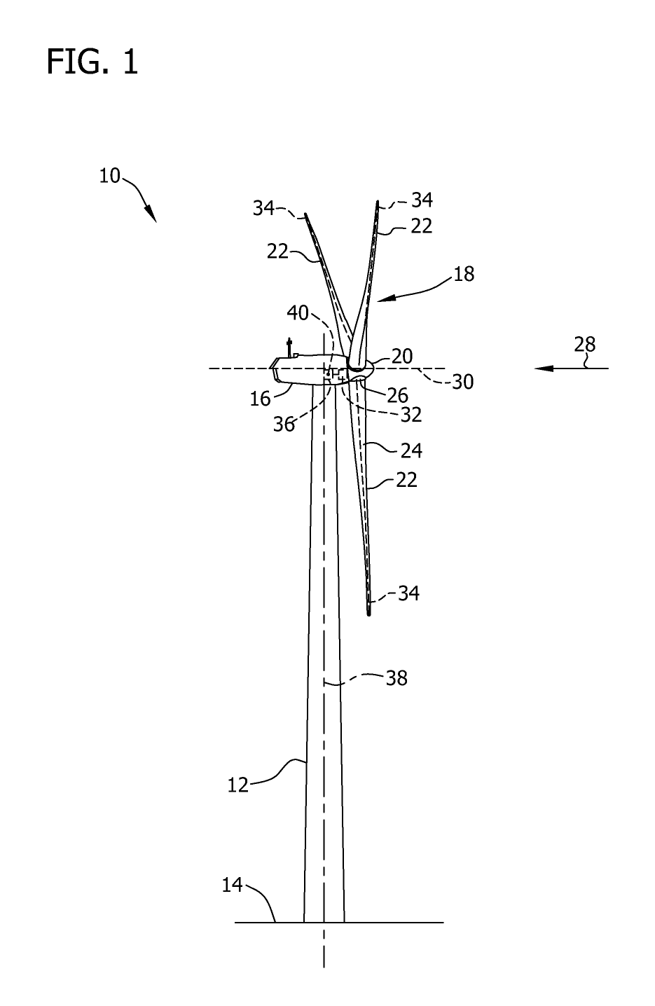

FIG. 1 is a perspective view of an exemplary wind turbine 10. In the exemplary embodiment, wind turbine 10 is a horizontal-axis wind turbine. Alternatively, wind turbine 10 may be a vertical-axis wind turbine. In the exemplary embodiment, wind turbine 10 includes a tower 12 that extends from a support system 14, a nacelle 16 mounted on tower 12, and a rotor 18 that is coupled to nacelle 16. Rotor 18 includes a rotatable hub 20 and at least one rotor blade 22 coupled to and extending outward from hub 20. In the exemplary embodiment, rotor 18 has three rotor blades 22. In an alternative embodiment, rotor 18 includes more or less than three rotor blades 22. In the exemplary embodiment, tower 12 is fabricated from tubular steel to define a cavity (not shown in FIG. 1) between support system 14 and nacelle 16. In an alternative embodiment, tower 12 is any suitable type of tower having any suitable height.

Rotor blades 22 are spaced about hub 20 to facilitate rotating rotor 18 to enable kinetic energy to be transferred from the wind into usable mechanical energy, and subsequently, electrical energy. Rotor blades 22 are mated to hub 20 by coupling a blade root portion 24 to hub 20 at a plurality of load transfer regions 26. Load transfer regions 26 have a hub load transfer region and a blade load transfer region (both not shown in FIG. 1). Loads induced to rotor blades 22 are transferred to hub 20 via load transfer regions 26.

In one embodiment, rotor blades 22 have a length ranging from about 15 meters (m) to about 91 m. Alternatively, rotor blades 22 may have any suitable length that enables wind turbine 10 to function as described herein. For example, other non-limiting examples of blade lengths include 10 m or less, 20 m, 37 m, or a length that is greater than 91 m. As wind strikes rotor blades 22 from a direction 28, rotor 18 is rotated about an axis of rotation 30. As rotor blades 22 are rotated and subjected to centrifugal forces, rotor blades 22 are also subjected to various forces and moments. As such, rotor blades 22 may deflect and/or rotate from a neutral, or non-deflected, position to a deflected position.

Moreover, a pitch angle or blade pitch of rotor blades 22, i.e., an angle that determines a perspective of rotor blades 22 with respect to direction 28 of the wind, may be changed by a pitch adjustment system 32 to control the load and power generated by wind turbine 10 by adjusting an angular position of at least one rotor blade 22 relative to wind vectors. Pitch axes 34 for rotor blades 22 are shown. During operation of wind turbine 10, pitch adjustment system 32 may change a blade pitch of rotor blades 22 such that rotor blades 22 are moved to a feathered position, such that the perspective of at least one rotor blade 22, relative to wind vectors, provides a minimal surface area of rotor blade 22 to be oriented towards the wind vectors, which facilitates reducing a rotational speed of rotor 18 and/or facilitates a stall of rotor 18.

In the exemplary embodiment, control system 36 is shown as being centralized within nacelle 16, however, control system 36 may be a distributed system throughout wind turbine 10, on support system 14, within a wind farm, and/or at a remote control center. Control system 36 includes a processor 40 configured to perform the methods and/or steps described herein. Further, many of the other components described herein include a processor. As used herein, the term “processor” is not limited to integrated circuits referred to in the art as a computer, but broadly refers to a controller, a microcontroller, a microcomputer, a programmable logic controller (PLC), an application specific integrated circuit, and other programmable circuits, and these terms are used interchangeably herein. It should be understood that a processor and/or a control system can also include memory, input channels, and/or output channels.

In the embodiments described herein, memory may include, without limitation, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, input channels include, without limitation, sensors and/or computer peripherals associated with an operator interface, such as a mouse and a keyboard. Further, in the exemplary embodiment, output channels may include, without limitation, a control device, an operator interface monitor and/or a display.

Processors described herein process information transmitted from a plurality of electrical and electronic devices that may include, without limitation, sensors, actuators, compressors, control systems, and/or monitoring devices. Such processors may be physically located in, for example, a control system, a sensor, a monitoring device, a desktop computer, a laptop computer, a programmable logic controller (PLC) cabinet, and/or a distributed control system (DCS) cabinet. RAM and storage devices store and transfer information and instructions to be executed by the processor(s). RAM and storage devices can also be used to store and provide temporary variables, static (i.e., non-changing) information and instructions, or other intermediate information to the processors during execution of instructions by the processor(s). Instructions that are executed may include, without limitation, wind turbine control system control commands. The execution of sequences of instructions is not limited to any specific combination of hardware circuitry and software instructions.

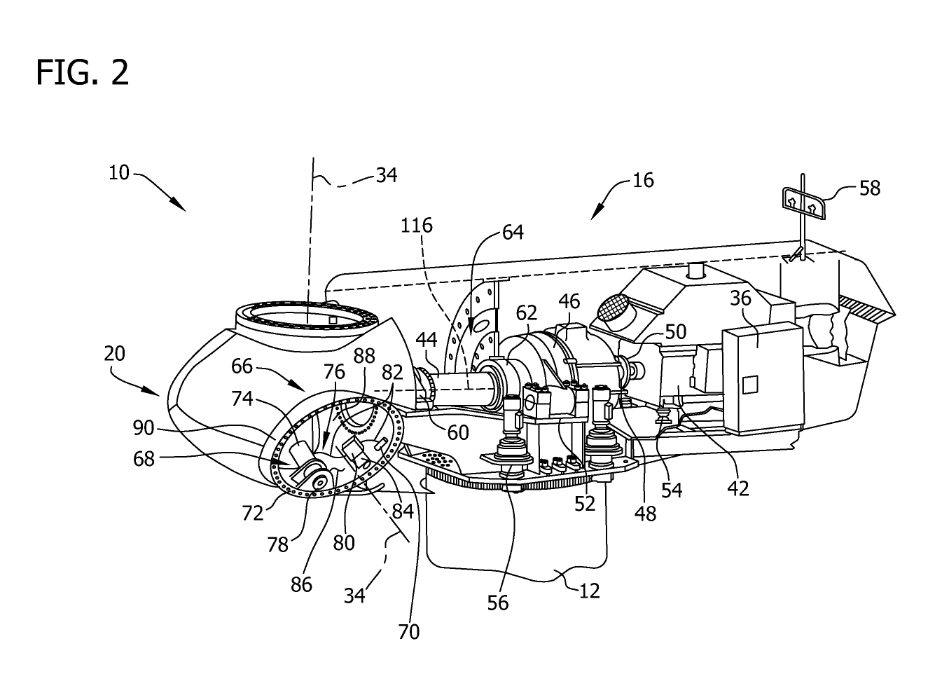

FIG. 2 is an enlarged sectional view of a portion of wind turbine 10. In the exemplary embodiment, wind turbine 10 includes nacelle 16 and hub 20 that is rotatably coupled to nacelle 16. More specifically, hub 20 is rotatably coupled to an electric generator 42 positioned within nacelle 16 by rotor shaft 44 (sometimes referred to as either a main shaft or a low speed shaft), a gearbox 46, a high speed shaft 48, and a coupling 50. In the exemplary embodiment, rotor shaft 44 is disposed coaxial to longitudinal axis 116. Rotation of rotor shaft 44 rotatably drives gearbox 46 that subsequently drives high speed shaft 48. High speed shaft 48 rotatably drives generator 42 with coupling 50 and rotation of high speed shaft 48 facilitates production of electrical power by generator 42. Gearbox 46 and generator 42 are supported by a support 52 and a support 54. In the exemplary embodiment, gearbox 46 utilizes a dual path geometry to drive high speed shaft 48. Alternatively, rotor shaft 44 is coupled directly to generator 42 with coupling 50.

Nacelle 16 also includes a yaw drive mechanism 56 that may be used to rotate nacelle 16 and hub 20 on yaw axis 38 (shown in FIG. 1) to control the perspective of rotor blades 22 with respect to direction 28 of the wind. Nacelle 16 also includes at least one meteorological mast 58 that includes a wind vane and anemometer (neither shown in FIG. 2). Mast 58 provides information to control system 36 that may include wind direction and/or wind speed. In the exemplary embodiment, nacelle 16 also includes a main forward support bearing 60 and a main aft support bearing 62.

Forward support bearing 60 and aft support bearing 62 facilitate radial support and alignment of rotor shaft 44. Forward support bearing 60 is coupled to rotor shaft 44 near hub 20. Aft support bearing 62 is positioned on rotor shaft 44 near gearbox 46 and/or generator 42. Alternatively, nacelle 16 includes any number of support bearings that enable wind turbine 10 to function as disclosed herein. Rotor shaft 44, generator 42, gearbox 46, high speed shaft 48, coupling 50, and any associated fastening, support, and/or securing device including, but not limited to, support 52 and/or support 54, forward support bearing 60 and aft support bearing 62, are sometimes referred to as a power train 64.

Typically, multi-megawatt wind turbines include high power, high density machinery (such as gearbox and generator) mounted on large structures. Energy conversion in the machinery may lead to residual dynamic forces, which may cause structure-borne noise. Generally, rotating stages of a gear or pole meshing of a generator may lead to a structure-borne noise having a tonal nature which results in an unwanted noise emission. The noise emission may lead to noticeable far field disturbances, neighborhood claims and law enforcement. In view of the noise emission, technical solutions to mitigate structure-borne tonal noise of the machinery gear or pole meshing are desirable.

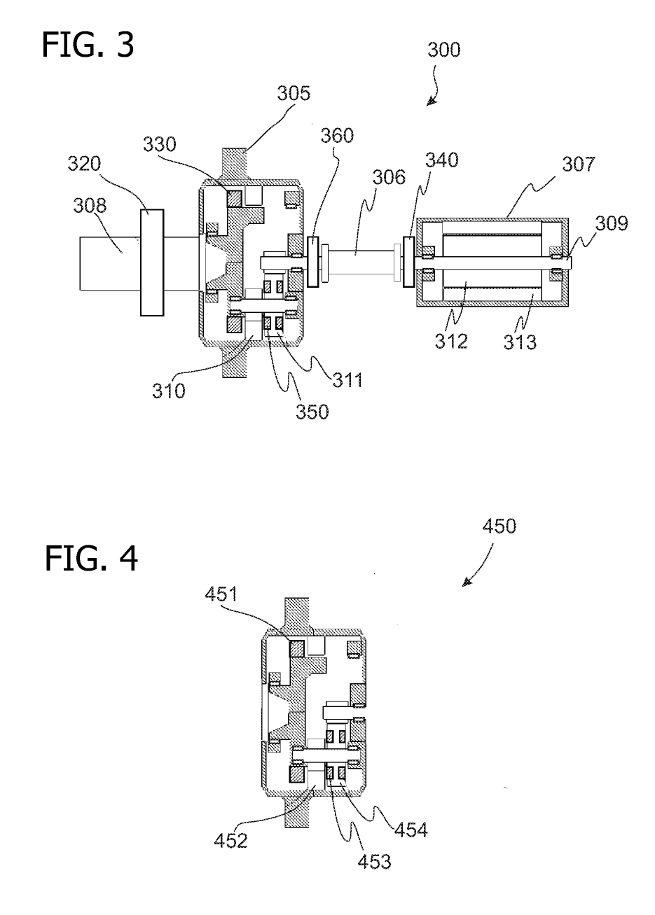

FIG. 3 shows a cross-sectional view of a power train 300 of a wind turbine according to embodiments described herein. The power train 300 typically includes a gearbox 305, a generator 307, a rotor input main low speed shaft 308 and an output high speed shaft 309. According to some embodiments, the gearbox 305 includes a single or multiple complimentary gear stage(s) 310 and 311. A coupling shaft 306 may connect the gearbox 305 with the generator 307 including a rotor 312 and a stator 313. According to some embodiments, a vibration damping device 320 specifically designed for the low speed stage of the gearbox 305, is mounted on the low speed input shaft 308. Typically, a vibration damping device 330, which is specifically designed for the high speed stage of the gearbox 305, is mounted at the output shaft of the high speed stage of the gearbox. Further, a vibration damping device 340, which is specifically designed for the rotor of the generator 307, may be mounted on the output shaft 309.

According to some embodiments, a vibration absorbing device 350 is specifically designed for a planetary stage of the gearbox 305 and is mounted on the planet carrier housing of the gearbox. Further, a vibration absorbing device 360, which is specifically designed for a gearbox spur or a helicoidal gear pair stage, is typically mounted on one or two sides of the gearbox. Thus, as can be seen in FIG. 3, one or more vibration absorbing devices may be arranged at the power train of a wind turbine, according to embodiments described herein.

As can be seen in FIG. 3, the vibration absorbing device according to embodiments described herein may be mounted on inter-connecting shafts of the machinery (also called external application, for instance devices 320 and 340 in FIG. 3), on an internal rotor shaft of the machinery (for instance, device 340 of FIG. 3 may be located outside or inside the generator rotor), on an internal gear shaft of the machinery (such as device 330 in the gearbox 305 of FIG. 3), on a planetary gear stage planet carrier (such as device 350 in the gearbox 305 of FIG. 3). Typically, the vibration absorbing device may either be mounted on a shaft or a planet carrier and seldom on a bearing.

Further, the vibration absorbing device may typically be adapted for external coupling shaft installation (outside of the machinery) or internal shaft or bearing ring installation (inside of machinery). In the case that an internal use of the vibration absorbing device is intended (such as using the vibration absorbing device inside the gearbox, on a rotating shaft of the gear, and/or on a gear stage carrier), the vibration absorbing device may be equipped with a protective sealed cover, such as a housing or the like. For instance, device 330 shown in FIG. 3 may include a vibration absorbing device as described in detail below and a protective housing surrounding the vibration absorbing device. The protective cover keeps the vibration absorbing device away from the lubrication oil flow or the air/liquid cooling flow. Generally, the lubrication oil or another fluid flow surrounding the vibration absorbing device would influence the operation of the vibration absorbing device, such as the frequencies to be absorbed.

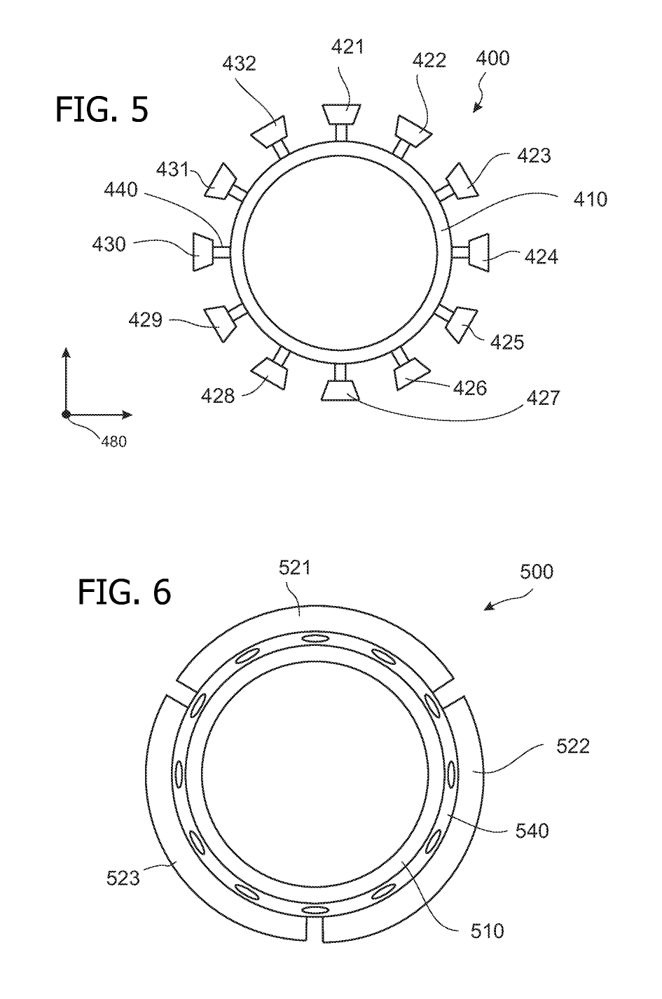

FIG. 4 shows an embodiment of a gearbox having a vibration absorbing device according to embodiments described herein. Typically, the gearbox includes a shaft, which may be a shaft of any of the stages of the gearbox 450. Further, the gearbox 450 includes one or more vibration absorbing devices 451, 452, 453, and 454, on one or more shafts of the gearbox which may be vibration absorbing devices as described with respect to FIG. 3. Generally, the one or more vibration energy storing assemblies may include a vibration energy storing assembly including a flexible element and a mass assembly on the flexible element. According to some embodiments, the mass assembly is arranged substantially axially symmetric to the shaft axis of the shaft, on which the vibration energy storing assembly is arranged. Typically, the vibration energy storing assembly/assemblies may be vibration absorbing device as in detail described below with respect to FIGS. 5 to 9.

In FIG. 5, an example of a vibration damping device is shown as may be used in the power train of FIG. 3. According to some embodiments, the vibration absorbing device 400 includes a mounting flange or ring 410, which is used for connecting and fixing the vibration absorbing device on a shaft of the power train of the wind turbine. Examples of shafts, on which the vibration absorbing device may be mounted, are described with respect to FIG. 3. Typically, a mass assembly 420 is mounted on the ring 410. According to some embodiments, the mass assembly may include more than one mass element, as shown in FIG. 5 by mass elements 421, 422, 423, 424, 425, 426, 427, 428, 429, 430, 431, and 432. Typically, the mass assembly is mounted to the ring 410 through flexible elements 440, which may exemplarily be spring elements. In FIG. 5, only one flexible element is denoted with the reference number 440 for the sake of clarity.

Generally, the mass of the mass assembly or the mass elements influences the frequencies, which may be absorbed by the vibration absorbing device. For instance, the vibrations caused by a low speed component of the wind turbine may be absorbed by a vibration absorbing device having a greater mass than a vibration absorbing device for absorbing vibrations of a high speed component of the wind turbine. Further, the axial as well as the torsional stiffness may be determined by the parameters of the flexible spring elements of the vibration absorbing device. According to some embodiments, the mass assembly and the parameter of the flexible elements may be sized and dimensioned to selectively reduce the gear meshing frequency vibration (dynamic force excitation source) of the low speed and medium speed gear stage of the gearbox. According to further embodiments, the mass assembly and the parameter of the flexible elements may be sized and dimensioned to selectively reduce the gear meshing frequency vibration (dynamic force excitation source) of the medium speed and high speed gear stage of the gearbox. According to yet further embodiments, the mass assembly and the parameter of the flexible elements may be sized and dimensioned to selectively reduce the rotor-stator pole meshing frequency vibration (dynamic force excitation source) of the generator.

Typically, the vibration absorbing device provides an axially symmetric arrangement of the mass assembly and the flexible elements. According to some embodiments, the term “axially symmetric” means that the mass is symmetrically distributed with respect to the axial direction, which is exemplarily shown as axis 480 in FIG. 5. Also, the term “axially symmetric” may describe the situation, where the center of inertia of the mass assembly is substantially located on the shaft axis.

The term “substantially” as used herein may mean that there could be a certain deviation from the characteristic denoted with “substantially.” Typically, the term “substantially symmetrical” may also mean that the elements are not exactly arranged symmetrically, but may deviate from the symmetrical arrangement to some extent, e.g. to some percent of the total extension of the element.

According to some embodiments, the mass assembly of the vibration absorbing device mounted to the ring through flexible elements may have a specific first natural frequency fₓ₁ normal to the rotation plane (such as in the axial direction) in order to absorb an axial vibration component of a selected gear meshing frequency. Further, the mass assembly of the vibration absorbing device may have a second natural frequency f_{y1}, different from the first natural frequency fₓ₁, within the rotation plane of the vibration absorbing device in order to absorb a torsional vibration component of a selected gear meshing frequency. According to some embodiments, the mass assembly of the vibration absorbing device may have a third natural frequency f_{z1} within the rotation plane in order to absorb a vibration torsional component of a selected gear meshing frequency.

Typically, the vibration absorbing devices, as exemplarily described as absorbing devices 320, 330, 340, 350, and 360 in FIG. 3, may act as a series of acting mass elements (typically more than three) having a specific axial (with the frequency fₓ₁), radial (with the frequency f_{y1}) and an additional torsional (with the frequency f_{z1}) dynamic absorption (e.g., by means of the resonance of the mass elements and the flexible or spring connection element, i.e. by a “nodalizing” effect induced by mechanical admittance).

Generally, with vibration absorbing devices, according to embodiments described herein, the detailed mass of the mass assembly, the center of gravity, the inertia value of the mass assembly, the flexural stiffness, the extensional stiffness, and the dimensions of the resonance of the flexible or spring connection element may be adjusted, in particular so that a frequency matching of frequencies in different directions is realized by a frequency pair for either (fₓ₁ and f_{y1}), or (f_{y1} and f_{z1}), or (f_{z1} and fₓ₁), or even (fₓ₁ and f_{y1} and f_{z1}).

Typically, by the adaption of the vibration absorbing devices, the vibration absorbing devices may act as a selective axial, radial or torsional dynamic vibration absorber by offering specific mechanical admittance near the frequencies fₓ₁ f_{y1}, and f_{z1} to the rotating shaft or bearing ring on which it is mounted to reduce the transfer of gear and/or pole meshing excitation directly at the relevant stage shaft or bearing.

According to some embodiments, the vibration absorbing devices as described herein may be rotated on a variable rotational speed so that the mechanical admittance characteristics near the frequencies fₓ₁ f_{y1}, and f_{z1} and the related dynamic absorption may be adapted to be spread over a specific range according to rotational speed range.

A further example of a vibration absorbing device, according to embodiments described herein, is shown in FIG. 6. The vibration absorbing device 500 typically includes a mass assembly, which exemplarily includes three mass elements 521, 522, and 523 in the embodiment shown in FIG. 6. According to some embodiments, the number of mass elements in a mass assembly of a vibration absorbing device may be greater than three, such as four, six, ten, or even above ten. According to a further embodiment, the mass assembly of a vibration absorbing device may be composed of only one mass element or two mass elements.

In the embodiment shown in FIG. 6, a ring 510 is provided for connecting and fixing the vibration absorbing device to a shaft of a wind turbine power train. Typically, the mass assembly may be mounted to the ring 510 by a flexible element 540, which may be a spring element. As can be seen in FIG. 6, the flexible element is formed by a material having a long-hole pattern machined therein so as to provide the flexible characteristic. Further examples of flexible elements are shown in detail below, especially with respect to FIGS. 10 to 14.

Typically, the vibration absorbing device as shown in the example of FIG. 6 may be denoted as a fixed single frequency vibration dynamic absorber (VDA) provided for the purpose of reducing vibrations by means of a single torsional resonant frequency per acting mass assembly (such as mass elements 521, 522, 523), which are mounted through a flexible or spring connection element. According to some embodiments, the characteristic of the flexible or spring element may be determined by the long-hole size and pattern.

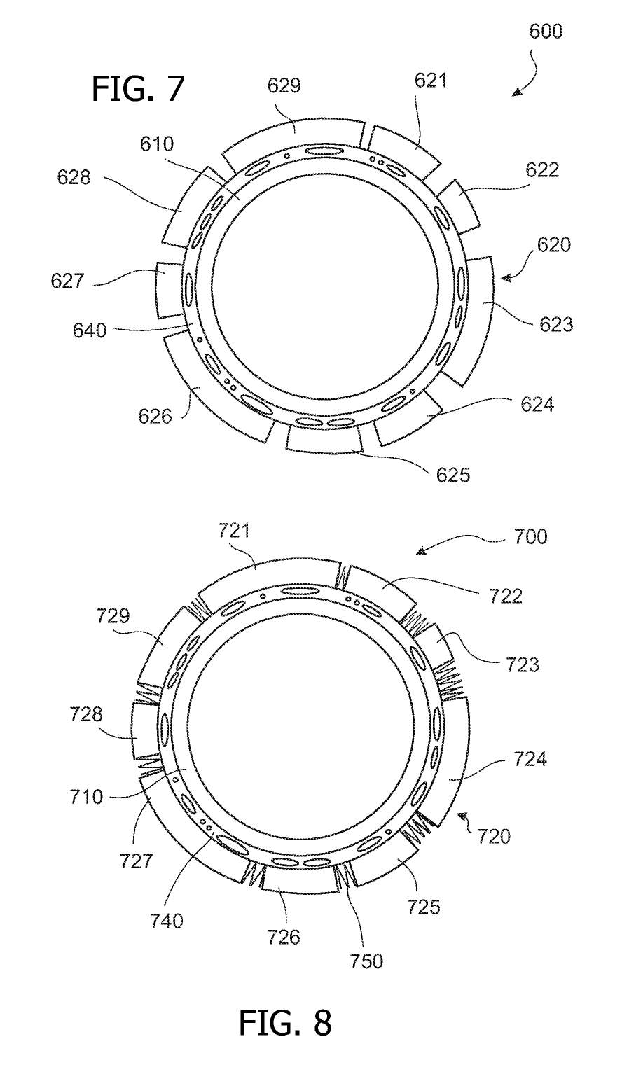

In FIG. 7, an embodiment of a vibration absorbing device according to some embodiments is shown. Typically, the vibration absorbing device 600 may be located in a power train of a wind turbine like the vibration absorbing devices 320, 330, 340, 350, and 360 as shown in FIG. 3. FIG. 7 shows a vibration absorbing device 600 including a ring 610 for mounting the vibration absorbing device to a respective shaft of the wind turbine. According to some embodiments, a mass assembly 620 may include several mass elements 621, 622, 623, 624, 625, 626, 627, 628, and 629. Typically, the mass of mass elements 621, 622, 623, 624, 625, 626, 627, 628, and 629 may vary dependent on the frequencies of the vibrations to be absorbed. In FIG. 7, different sizes of the mass elements indicate different masses. A flexible element 640 may be provided for mounting the mass elements 621, 622, 623, 624, 625, 626, 627, 628, and 629 to the ring 610. As can be seen in the example of FIG. 7, the flexible element may be an element having pattern of holes provided in it. For instance, the pattern of holes may include long-holes and/or substantially circular shaped holes. Typically, the flexible element 640 is adapted to the mass of the single mass elements. For instance, the pattern and size of the holes in the flexible element 640 are specifically determined for each mass element.

Typically, the vibration absorbing device as shown in the example of FIG. 7 may be denoted as a fixed multiple frequency vibration dynamic absorber for the purpose of reducing vibrations by means of multiple torsional resonant frequencies per several mass elements (such as mass elements 621, 622, 623, 624, 625, 626, 627, 628, and 629), which are mounted through a flexible or spring connection element (16) to the ring. According to some embodiments, the flexible or spring element may have a specific long-hole size and pattern determined for each mass element.

Typically, also a fixed single frequency vibration dynamic absorber may be provided for the purpose of reducing vibrations by means of a single torsional resonant frequency (defined by the ratio of the stiffness in the rotational plane versus mass element for the target operating rotational speed) and a matched coupled axial resonant frequency (defined by the ration of axial stiffness versus mass element).

According to further embodiments described herein, a combination of the features of the above described embodiments may be provided so as to form a fixed multiple frequency vibration dynamic absorber for the purpose of vibration reduction by means of multiple torsional resonant frequencies (defined by the ratio of the stiffness in the rotational plane versus mass element) and a matched coupled axial resonant frequency (defined by the ratio of the axial stiffness versus mass element).

According to further embodiments described herein, a fixed multiple frequency vibration dynamic absorber may be provided for the purpose of reducing vibrations by means of multiple torsional resonant frequencies (in plane stiffness versus mass element) and multiple axial resonant frequencies (axial stiffness versus mass element). Typically, the frequency ratio in between individual resonant elements is a linear progression (for example, in FIG. 6, mass element 623 resonates at 50 Hz, mass element 621 resonates at 100 Hz, and mass element 622 resonates at 150 Hz with cumulative vibration reduction over three steps of 50 Hz with linear progression).

Typically, also a fixed multiple frequency vibration dynamic absorber for the purpose of vibration reduction by means of multiple torsional resonant frequencies (in plane stiffness versus mass element) and multiple axial resonant frequencies (axial stiffness versus mass element) may be provided, where the frequency ratio in between individual resonant elements is a logarithmic progression. For example, in FIG. 6, mass element 623 resonates at 100 Hz, mass element 621 resonates at 200 Hz, and mass element 622 resonates at 400 Hz with cumulative vibration reduction over three steps with a frequency region of 100-400 Hz with 2:1 ratio logarithmic progression.

FIG. 8 shows an embodiment of the vibration absorbing device which may be combined with other embodiments described herein. Typically, the vibration absorbing device 700 may be located in a power train of a wind turbine like the vibration absorbing devices 320, 330, 340, 350, and 360 as shown in FIG. 3. FIG. 8 shows a vibration absorbing device 700 including a ring 710 for mounting the vibration absorbing device to a respective shaft of the wind turbine. According to some embodiments, a mass assembly 720 may include several mass elements 721, 722, 723, 724, 725, 726, 727, 728, and 729. Typically, the mass of mass elements 721, 722, 723, 724, 725, 726, 727, 728, and 729 may vary dependent on the frequencies of the vibrations to be absorbed. In FIG. 8, different sizes of the mass elements indicate different masses. A flexible element 740 may be provided for mounting the mass elements 721, 722, 723, 724, 725, 726, 727, 728, and 729 to the ring 610. Typically, the flexible element 640 is adapted to the mass of the single mass elements. For instance, the pattern and size of the holes in the flexible element 740 are specifically determined for each mass element.

Further, the vibration absorbing device 700 includes inter-connecting elements 750 between the mass elements. For the sake of clarity, only one inter-connecting element is denoted with the reference number 750 in FIG. 8. The inter-connecting elements 750 may be pre-loading springs, which are able to provide a defined stiffness between the mass elements. According to some embodiments described herein, the inter-connecting elements between mass elements of a mass assembly of a vibration absorbing device allow for covering variable frequencies by one vibration absorbing device. Typically, the inter-connecting springs or perimeter springs may be provided in several shapes and is not limited to the example shown in FIG. 8. For instance, the inter-connecting springs may include a simply machined single “U”-shape or a “wave pattern” of metallic or non-metallic parts, such as laminated or wound composite parts. According to some embodiments, the shape and material of the inter-connecting spring elements may be chosen dependent on the design for the specific frequency range and the intended spring- and pre-load-function distributed around the perimeter of the vibration absorbing device.

A vibration absorbing device, including inter-connecting elements, such as spring elements, between the single mass elements of the mass assembly, may be denoted as a variable multiple frequency vibration dynamic absorber.

A progressive variable multiple frequency VDA may be designed for the purpose of reducing vibrations over a specific RPM range (such as 500-1000 RPM) by providing multiple torsional resonant frequencies (in plane stiffness versus mass element) and multiple axial resonant frequencies (axial stiffness versus mass element). Typically, the frequency ratio in between individual resonant elements is a linear progression (for example, in FIG. 8, element 724 resonates from about 50 Hz to about 100 Hz, element 722 resonates from about 100 Hz to about 200 Hz and element 723 resonates from about 150 Hz to about 300 Hz), with cumulative vibration reduction over three steps of 50 Hz with linear progression.

According to further embodiments, the vibration absorbing device may be a progressive variable multiple frequency vibration dynamic absorber. The progressive variable multiple frequency VDA may be designed for the purpose of reducing vibrations over a specific RPM range by providing multiple torsional resonant frequencies (in plane stiffness versus mass element) and multiple axial resonant frequencies (axial stiffness versus mass element) where the frequency ratio in between individual resonant element is a logarithmic progression (for example, per FIG. 7, mass element 724 resonates with a frequency from about 100 Hz to about 200 Hz, mass element 722 resonates with a frequency from about from about 200 Hz to about 400 Hz, and mass element 723 resonates from 400 Hz up to 800 Hz with cumulative vibration reduction over three steps in a 100-800 Hz frequency region with 2:1 ratio logarithmic progression).

Typically, a progressive variable multiple frequency vibration dynamic absorber may be provided for the purpose of vibration reduction over a specific RPM range by providing multiple torsional resonant frequencies per several mass elements. The mass elements may be mounted through a flexible or spring connection element having a specific determined long-hole size and pattern for each mass element.

Typically, the features of the above described embodiments may be combined so as to provide a progressive variable single frequency vibration dynamic absorber, which is provided for the purpose of reducing vibrations over a specific RPM range by providing a single torsional resonant frequency per acting mass elements. According to some embodiments, the mass elements may be mounted to a ring using a flexible or spring connection element (whose characteristic may be exemplarily determined by a long-hole size and a long-hole pattern).

According to yet further embodiments, a progressive variable single frequency vibration dynamic absorber may be provided for the purpose of reducing vibrations over a specific RPM range by providing a single torsional resonant frequency (in plane stiffness versus mass element) and a matched coupled axial resonance (axial stiffness versus mass element).

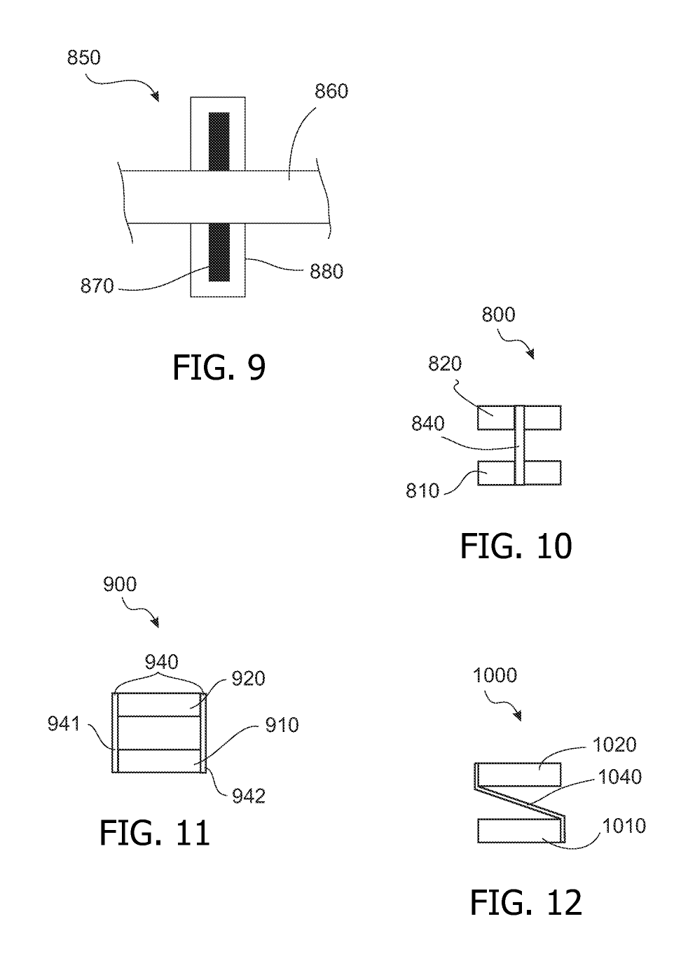

FIG. 9 shows an embodiment of a vibration absorbing arrangement 850. The vibration absorbing arrangement 850 is shown mounted on a shaft 860. The vibration absorbing arrangement may include a housing 880 and a vibration absorbing device 870, which may be a vibration absorbing device as described above. Typically, the housing 880 is adapted to prevent an influence of a fluid flow to the vibration absorbing characteristic of the vibration absorbing device. For instance, the housing may seal the environment of the vibration absorbing device 870 from fluid influences of the environment in which the shaft 860 operates, such as oil, lubrication fluids, cooling fluids, and the like. Typically, the housing may contain seals which provide the sealing function of the housing.

Typically, the vibration absorbing device may be produced in different ways. For instance, the vibration absorbing device including a flexible element and a mass assembly may be a vibration dynamic absorber having a sandwich metallic construction for the purpose of reducing the vibration. A Sandwich construction may be provided by a separate ring, a separate mass assembly and a separate flexible element mounted to each other. Typically, the flexible element may be mounted to the ring and the mass assembly may be mounted to the flexible element.

According to some embodiments, the vibration absorbing device may be designed as a laminated hybrid composite-metal construction vibration dynamic absorber for the purpose of reducing vibrations. For instance, a mounting flange or ring and a mass assembly having one or more mass elements are mounted onto a flexible or spring element of a composite fiber-reinforced plastic in order to provide the selective rotational plane and axial stiffness.

According to further embodiments, the vibration absorbing device may be designed as a monolithic vibration dynamic absorber (VDA) for the purpose of reducing vibrations. For instance, the mounting flange or ring and the mass assembly having one or more mass elements are arranged on a flexible or spring element machined from a single block material, wherein a pattern in the flexible element leads to the specific geometry and characteristic of the flexible element.

Generally, the vibration absorbing device according to embodiments described herein may be made from a material or several materials and a corresponding assembly method, wherein the material(s) may have very low damping properties in order to provide a maximized dynamic absorption of the vibration instead of damping the vibration. In the case, where several materials are used, the materials may typically be arranged in a laminated form or in a wound form.

Typically, the features of the above described embodiments of the vibration absorbing device may be combined. For instance a vibration dynamic absorber having a sandwich metallic construction, a monolithic construction or a laminated hybrid composite-metal construction may be provided for the purpose of reducing vibrations, wherein the mounting flange or ring and the mass assembly are mounted onto a flexible or spring connection element together with pre-loading spring elements in the perimeter direction, as shown, for instance, by inter-connecting elements 750 in FIG. 8.

According to some embodiments described herein, the vibration absorbing device may be used for absorbing vibrations having a frequency in the range of typically from about 10 Hz to about 1500 Hz, more typically from about 20 Hz to about 1200 Hz, and even more typically from about 50 Hz to about 1000 Hz.

Examples of the different constructions of the vibration absorbing device are shown in FIGS. 10 to 14. FIG. 10 shows an embodiment of a vibration absorbing device 800, which may be combined with other embodiments described herein, in a cross sectional view. Typically, the vibration absorbing device 800 includes a ring 810 for mounting the vibration absorbing device 800 to a shaft of a wind turbine, a mass assembly 820 and a flexible element 840. As can be seen in FIG. 10, the ring 810, the mass assembly 820, and the flexible element 840 are separate components mounted to each other.

FIG. 11 shows, in a cross sectional view, another embodiment of a vibration absorbing device 800, which may be combined with other embodiments described herein. Typically, the vibration absorbing device 900 includes a ring 910 for mounting the vibration absorbing device 900 to a shaft of a wind turbine, a mass assembly 920 and a flexible element 940. As can be seen in FIG. 11, the ring 910, the mass assembly 920, and the flexible element 940 are separate components mounted to each other. In the embodiment shown in FIG. 11, the flexible element is provided by two distinct components 941, 942 on either side of the mass assembly.

FIG. 12 shows an embodiment of a vibration absorbing device 1000, which may be combined with other embodiments described herein, in a cross sectional view. Typically, the vibration absorbing device 1000 includes a ring 1010 for mounting the vibration absorbing device 1000 to a shaft of a wind turbine, a mass assembly 1020 and a flexible element 1040. As can be seen in FIG. 12, the ring 1010, the mass assembly 1020 and the flexible element 1040 are separate components mounted to each other. In the embodiment shown in FIG. 12, the flexible element 1010 is provided in a bent shape ranging from one side of the mass assembly 1020 to the other side of the mass assembly 1020.

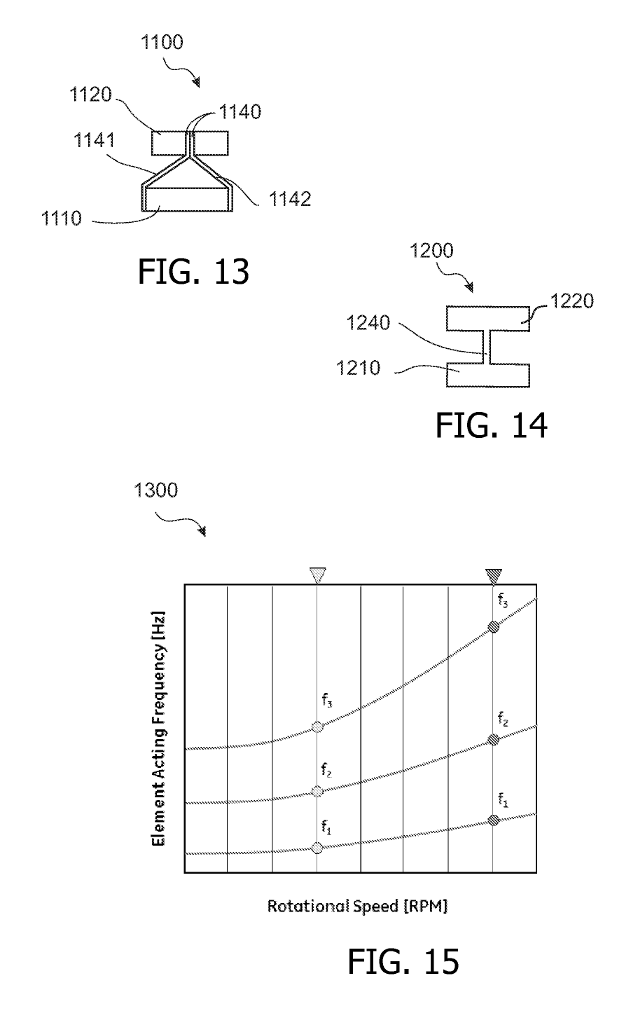

FIG. 13 shows an embodiment of a vibration absorbing device 1100, which may be combined with other embodiments described herein, in a cross sectional view. Typically, the vibration absorbing device 1100 includes a ring 1110 for mounting the vibration absorbing device 1100 to a shaft of a wind turbine, a mass assembly 1120 and a flexible element 1140. As can be seen in FIG. 12, the ring 1110, the mass assembly 1120 and the flexible element 1140 are separate components mounted to each other. In the embodiment shown in FIG. 12, the flexible element 1110 is provided by two flexible components 1141 and 1142 in a bent shape.

FIG. 14 shows an embodiment of a vibration absorbing device 1200, which may be combined with other embodiments described herein, in a cross sectional view. Typically, the vibration absorbing device 1200 includes a ring 1210 for mounting the vibration absorbing device 1200 to a shaft of a wind turbine, a mass assembly 1220 and a flexible element 1240. As can be seen in FIG. 14, the ring 1210, the mass assembly 1220, and the flexible element 1240 are formed from one piece of material, which may be referred to as being monolithic.

Typically, the flexible or spring element is designed so that it features a progressive stiffness variation characteristic so that a resonant frequency pair for either (fₓ₁ and f_{y1}), (f_{y1} and f_{z1}), or (f_{z1} and fₓ₁) are progressively shifting the frequency. This may be realized by means of centrifugal stiffening over a wide rotational speed range.

According to some embodiments, the flexible or spring element together with inter-connecting or pre-loading spring elements (as exemplarily shown as spring elements 750 in FIG. 8) are designed so that the flexible element features a progressive stiffness variation characteristic. The progressive stiffness variation characteristic allows for progressively shifting the frequency of the resonant frequency pairs of either (fₓ₁ and f_{y1}), (f_{y1} and f_{z1}), or (f_{z1} and fₓ₁) with a specific frequency offset(s) per perimeter inter-connecting or pre-loading spring elements. This may be realized by means of centrifugal stiffening over a wide rotational speed range.

A schematic diagram 1300 of the operation range of a variable vibration absorbing device of a wind turbine according to embodiments described herein is shown in FIG. 15. Typically, the vibration dynamic absorber used for the data given in FIG. 15 includes inter-connecting spring elements (as, for instance, shown in FIG. 8 as elements 750). Frequencies f₁ to f₃ of the vibrations, which may be absorbed by a variable vibration absorbing device, according to embodiments described herein, are shown, over the rotational speed, in the diagram of FIG. 15.

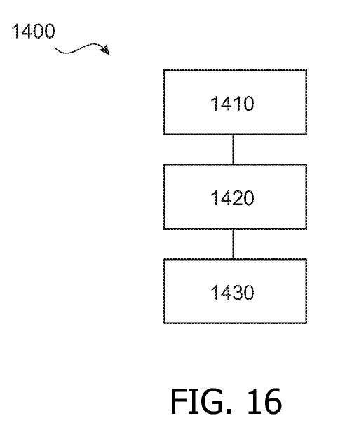

According to some embodiments, a method for absorbing vibrations of a wind turbine is provided. A flow chart of a method is shown in FIG. 16. Typically, the method 1400 is a method for absorbing vibrations in a wind turbine including a power train, which includes a gearbox, a generator and a rotatable shaft including a radial direction and an axial direction along a shaft axis. According to some embodiments, block 1410 includes providing a vibration absorbing device. Typically, the vibration absorbing device may be a vibration absorbing device as described above with respect to FIGS. 3 to 14. Generally, the vibration absorbing device includes a mass-spring assembly around a shaft of the power train of the wind turbine. According to some embodiments, the vibration absorbing device may be arranged with the center of inertia substantially on the shaft axis.

In block 1420, the vibration energy from the shaft is transmitted to the vibration absorbing device. Typically, the vibration energy from the shaft is transmitted by a mounting ring or flange of the vibration absorbing device, which is adapted to be connected to the respective shaft of the wind turbine.

According to some embodiments, the vibration energy transmitted from the shaft to the vibration absorbing device is stored in a mass-spring assembly of the vibration absorbing device in block 1430. For instance, the energy may be stored in a spring and may be released at a later point in time by releasing the spring.

Typically, the vibration absorbing device provided for absorbing the vibrations of the shaft may include an inner ring for connecting the vibration absorbing device to a shaft of the wind turbine and an energy storing assembly including a flexible element and a mass assembly. According to some embodiments, the mass assembly is arranged on the shaft in an axially symmetric way.

The method according to embodiments described herein may further include providing a mass assembly including at least two mass elements (such as a mass assembly as shown in FIGS. 5 to 8). Further, the method may typically include providing a spring element, such as inter-connecting elements 750 shown in FIG. 8, between the at least two mass elements.

According to some embodiments, the vibration absorbing device used for carrying out the method for absorbing vibrations in a wind turbine is located in the power train of the wind turbine, in particular on an input shaft of the gearbox, on an output shaft of the gearbox, on a shaft of the gearbox, and/or on an input shaft of the generator. Typically, more than one absorbing device may be arranged in a power train of a wind turbine. For instance, several vibration absorbing devices may be provided, such as absorbing devices 320, 330, 340 and 350, as shown in FIG. 3.

The method for absorbing vibrations according to embodiments described herein may be used for absorbing vibrations having a frequency in the range of typically from about 10 Hz to about 1500 Hz, more typically from about 20 Hz to about 1200 Hz, and even more typically from about 50 Hz to about 1000 Hz.

As described in detail above, the vibration absorbing device according to embodiments described herein may be provided with single or multiple “meshing” frequency vibration reduction. Further, the vibration absorbing device may be used in on-shore applications (air-borne) and off-shore applications (air-borne/underwater) of wind turbines.

The above-described systems and methods facilitate reducing the total noise emission of a wind turbine rotating machinery, which often includes a disturbing tonal noise characteristic, by adding vibration dynamic absorber device(s) at the vibration source in the machinery of the wind turbine. More specifically, embodiments described herein allow for reducing the vibrations at the source of the vibrations, such as gearbox gear “meshing” or generator pole “meshing”. For this purpose, the vibration absorbing device according to embodiments described herein may be adapted for being mounted on a shaft outside the machinery, such as a rotating input shaft, or the housing.

According to further aspects, the embodiments of a vibration absorbing device may provide the following, desirable effects. For instance, the dynamic vibration absorption is provided at the source directly and closest to the relevant stages. Typically, directly coupling the vibration absorbing device to the relevant gear or pole meshing stage provides a high reduction of vibrations and vibration induced tonal noise. Further, vibration absorbing devices, according to embodiments described herein, allow for a high ratio between vibration/noise reduction versus mass/cost. As the vibrations in the power train components are reduced, a further effect of using the vibration absorbing device, according to embodiments described herein, is the reduction in maintenance need, such as the maintenance of bearings and the like. For instance, a vibration absorbing device, according to embodiments described herein, may allow for a design with a 20-year lifespan without maintenance. Typically, the mass element of the vibration damping device may be designed for a 20-year lifetime as well as the mating surface of the mounting inner ring, which may be clamped without slip. For prolonging the lifetime of the flexible elements, a plurality of flexible elements with more than one interface to each mass element may be provided.

As shown above, the described effects may be achieved by a wind turbine including an integrated single or a series of vibration dynamic absorbers. Typically, each vibration dynamic absorber features an inner mounting interface, such as a ring or a flange, an outer monolithic or distributed mass assembly having one or more mass elements, and an intermediate flexible junction with specific flexibility axial and torsional characteristics relative to the outer monolithic or distributed mass assembly. Typically, each specific mass element(s) is coupled to a flexible junction and the specific local flexibility characteristics in both the axial and radial direction may have a neutral resonant frequency with preferably very low damping. Further, each vibration dynamic absorber having a monolithic or distributed mass assembly may act as a single or multiple resonant frequencies resonator in the axial and/or radial direction having the capacity of absorbing and storing kinetic energy. Absorbing and storing kinetic energy in a vibration absorbing device reduces the flow of vibration energy toward the outside of the machinery, which in turn decreases the related tonal noise emission from the entire vibrating structures.

Exemplary embodiments of systems and methods for a vibration absorbing device for a wind turbine are described above in detail. The systems and methods are not limited to the specific embodiments described herein, but rather, components of the systems and/or steps of the methods may be utilized independently and separately from other components and/or steps described herein. For example, the vibration absorbing device may be used as part of the machinery for further technical applications, and is not only limited to practice with the wind turbine systems as described herein. Rather, the exemplary embodiment can be implemented and utilized in connection with many other rotor blade applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A wind turbine, comprising:
a) a nacelle housing a power train of the wind turbine including a gearbox, a generator, and one or more rotatable shafts, each including a radial direction and an axial direction along a shaft axis; and,
b) a vibration absorbing device being arranged on a shaft of the power train, wherein the vibration absorbing device includes
i) a flexible element; and,
ii) a mass assembly, wherein the vibration absorbing device is arranged substantially axially symmetric to the shaft axis.

2. The wind turbine according to claim 1, wherein the mass assembly is positioned on the flexible element.

3. The wind turbine according to claim 1, wherein the mass assembly includes two or more mass elements.

4. The wind turbine according to claim 3, wherein the vibration absorbing device further includes a spring element arranged between mass elements in a circumferential direction.

5. The wind turbine according to claim 4, wherein the flexible elements and the spring elements in the circumferential direction are adapted to provide a variable vibration dynamic absorbing characteristic for multiple frequencies.

6. The wind turbine according to claim 3, wherein the parameters of the flexible element are adapted to the mass of a respective mass element.

7. The wind turbine according to claim 1, wherein the vibration absorbing device has a first natural frequency in the axial direction in order to absorb an axial vibration component and a second natural frequency in the rotation plane of the shaft in order to absorb a torsional vibration component.

8. The wind turbine according to claim 1, wherein the vibration absorbing device is surrounded by a housing for the vibration absorbing device, wherein the housing is adapted to prevent an influence of a fluid flow to the vibration absorbing characteristic of the vibration absorbing device.

9. The wind energy system according to claim 1, wherein the vibration absorbing device is located at least at one location of an input shaft of the gearbox, an output shaft of the gearbox, a shaft of the gearbox, and an input shaft of the generator.

10. A vibration absorbing device for a wind turbine including a shaft of a power train including a radial direction and an axial direction along a shaft axis, the vibration absorbing device comprising:
a) an inner ring for connecting the vibration absorbing device on a shaft of the wind turbine; and,
b) an energy storing assembly including a flexible element and a mass assembly on the flexible element, wherein the mass assembly is arranged substantially axially symmetric to the shaft axis.

11. The vibration absorbing device according to claim 10, wherein the vibration absorbing device is formed from a single material block.

12. The vibration absorbing device according to claim 10, wherein the vibration absorbing device is formed by a sandwich-structure.

13. The vibration absorbing device according to claim 10, wherein the mass assembly includes two or more mass elements.

14. The vibration absorbing device according to claim 10, wherein the center of inertia of the mass assembly is substantially located on the shaft axis.

15. The vibration absorbing device according to claim 10, wherein the vibration absorbing device has a first natural frequency in the axial direction in order to absorb an axial vibration component and a second natural frequency in the plane of rotation of the shaft in order to absorb a torsional vibration component.

16. A gearbox for a wind turbine, comprising:
a) a shaft including a radial direction and an axial direction along a shaft axis; and,
b) a vibration absorbing device on the shaft including a vibration energy storing assembly including a flexible element and a mass assembly on the flexible element, wherein the mass assembly is arranged substantially axially symmetric to the shaft axis.

17. The gearbox according to claim 16, wherein the vibration energy storing assembly is adapted for absorbing and storing vibrations of the shaft.

18. The gearbox according to claim 16, wherein the center of inertia of the mass assembly is substantially located on the shaft axis.

19. The gearbox according o claim 16, wherein the mass assembly includes at least two mass elements and wherein the vibration energy storing assembly includes a spring element between the at least two mass elements in circumferential direction in order to provide a variable vibration dynamic absorbing characteristic for multiple frequencies.

20. The gearbox according to claim 19, wherein the flexible elements and the spring elements in the circumferential direction are adapted to provide a variable vibration dynamic absorbing characteristic for multiple frequencies.
